(19) United States
(12) Patent Application Publication
(10) Pub. No.: US 2015/0367230 A1
(43) Pub. Date: Dec. 24, 2015

(54) PUZZLE CUBE AND COMMUNICATION SYSTEM

(71) Applicant: APPYCUBE LTD., Twickenham (GB)

(72) Inventors: Gary Bradford, Twickenham (GB); Andrew Crayton, Surrey (GB)

(73) Assignee: APPYCUBE LTD., Twickenham (GB)

(21) Appl. No.: 14/765,154

(22) PCT Filed: Jan. 31, 2014
(86) PCT No.: PCT/GB2014/050274

§ 371 Date: Jul. 31, 2015

(30) Foreign Application Priority Data
Feb. 1, 2013 (GB) 1301821.3
Jul. 31, 2013 (GB) 1313677.5

(51) Int. Cl. A63F 9/08; G06F 17/30

(52) U.S. Cl. CPC A63F 9/0842; G06F 17/3025; G06F 17/30321; A63F 2009/2457

(57) ABSTRACT

A system for accessing a database comprising a puzzle cube including a plurality of cubelets forming rotatable faces of the puzzle cube, wherein a plurality of different symbols are respectively provided on a plurality of faces of the cubelets. The system also comprises an image capturing device for capturing an image of a face of the puzzle cube and an image recognition component communicably connected to the image capturing device. The image recognition component is adapted to determine an arrangement of the symbols contained in the captured image. The system also includes a database containing a plurality of database entries, each database entry being indexed by an arrangement of the symbols, and a database access component communicably connected to the image recognition component and to the database. The database access component is adapted to access the database and retrieve the database entry indexed by the arrangement of symbols determined by the image recognition component.

The invention relates to a puzzle cube displaying a combination of different symbols on each face of the cube depending on the configuration of the puzzle cube. The invention also relates to a system and method for accessing a database either using the puzzle cube, a set of symbol dice or an array of symbols.

Puzzle cubes such as the familiar Rubik's cube (RTM) are well known. Such puzzle cubes consist of several smaller cubes or cubelets, which are attached to each other to form the puzzle cube so that each square face of cubelets can be rotated about an axis perpendicular to the face relative to the rest of the puzzle cube. Typically, puzzle cubes consist of a 3 by 3 by 3 arrangement of cubelets, meaning that each face of the puzzle cube is a 3 by 3 square of 9 cubelets and there are 26 cubelets in total in the puzzle cube. The cubelets are all attached to a central rotation mechanism that is hidden from view. The faces of the cubelets are different colours and the aim of the puzzle is to match the colours of the cubelets on each face of the puzzle cube by rotating the faces so that each face of the puzzle cube is a uniform colour.

Conventional dice are also well known, which have the numbers 1 to 6 displayed on their faces.

According to an aspect of the present invention, there is provided a puzzle cube including a plurality of cubelets forming rotatable faces of the puzzle cube, wherein a plurality of different symbols are respectively provided on a plurality of faces of the cubelets.

Since different symbols are attached to different cubelet faces, rotating the faces of the puzzle cube changes the combination and configuration of symbols displayed on each face of the puzzle cube. The vast number of possible symbol configurations on a given face of the cube can be used as labels in the same way as conventional barcodes for example.

Preferably, the puzzle cube further comprises a near field communication chip.

Preferably, each face of the cube comprises a 3 by 3 array of cubelets. In another embodiment, each face of the cube comprises a 2 by 2 array of cubelets.

According to another aspect of the present invention, there is provided a system for accessing a database comprising: a puzzle cube as described above; an image capturing device for capturing an image of a face of the puzzle cube; an image recognition component communicably connected to the image capturing device and adapted to determine an arrangement of the symbols contained in the captured image; a database containing a plurality of database entries, each database entry being indexed by an arrangement of the symbols; and a database access component communicably connected to the image recognition component and to the database, the database access component being adapted to access the database and retrieve the database entry indexed by the arrangement of symbols determined by the image recognition component.

Once the puzzle cube has been configured as desired by the user, the image displayed on a given face of the puzzle cube in the configuration is scanned and the image recognition component automatically determines the configuration of symbols on the face of the cube based on the image. The database access component then accesses the database using the symbol configuration as a search query. Since the database entries are indexed by possible symbol configurations, a corresponding database entry is returned provided that the particular symbol configuration used is included in the database.

According to another aspect of the present invention, there is provided a system for accessing a database comprising: one or more dice having a plurality of symbols respectively provided on faces of each die; an image capturing device for capturing an image of the faces of the dice; an image recognition component communicably connected to the image capturing device and adapted to determine an arrangement of the symbols contained in the captured image; a database containing a plurality of database entries, each database entry being indexed by an arrangement of the symbols; and a database access component communicably connected to the image recognition component and to the database, the database access component being adapted to access the database and retrieve the database entry indexed by the arrangement of symbols determined by the image recognition component.

By using the dice face symbol configurations in the same way as the puzzle cube face symbol configurations above, the same effects can be provided. In addition, the dice embodiment provides a built in way to generate a random symbol configuration, which makes this embodiment particularly suitable for a game environment.

Preferably, the image recognition component is adapted to determine the arrangement of the symbols on the upturned faces of the dice.

According to another aspect of the present invention, there is provided a system for accessing a database comprising: a recording medium or electronic display having an array of symbols displayed thereon; an image capturing device for capturing an image of the array of symbols; an image recognition component communicably connected to the image capturing device and adapted to determine an arrangement of the symbols contained in the captured image; a database containing a plurality of database entries, each database entry being indexed by an arrangement of the symbols; and a database access component communicably connected to the image recognition component and to the database, the database access component being adapted to access the database and retrieve the database entry indexed by the arrangement of symbols determined by the image recognition component.

The array of symbols has the advantage that it is relatively easy for the image recognition component to detect each individual symbol and their arrangement reliably, so that the overall combination of symbols can be reliably determined. It is also possible for users of the system to recognise and remember particular combinations of symbols that are familiar to them, which is not possible with a barcode for example.

Preferably, the array of symbols is a two-dimensional array. Suitably, the array of symbols includes at least two different symbols.

Preferably, the database entries are user profiles; the system further comprises a login component communicably connected to the database access component; and the login component is adapted to allow a user of the system to access the user profile indexed by the arrangement of symbols determined by the image recognition component.

According to another aspect of the present invention, there is provided a method for retrieving information from a database comprising: manipulating a puzzle cube as described above to produce an arrangement of symbols on a face of the puzzle cube; capturing an image of a face of the puzzle cube; automatically determining an arrangement of the symbols contained in the captured image; and accessing a database containing a plurality of database entries, each database entry being indexed by an arrangement of the symbols, using the determined arrangement of the symbols so as to retrieve the database entry associated with the determined arrangement of symbols.

According to this method, information can be retrieved from a database simply by scanning the puzzle cube to generate a search query. The method may be applied to an array of dice or an array of symbols described above as well as to a puzzle cube.

According to another aspect of the present invention, there is provided a method for adding information to a database comprising: manipulating a puzzle cube as described above to produce an arrangement of symbols on a face of the puzzle cube; capturing an image of a face of the puzzle cube; automatically determining an arrangement of the symbols contained in the captured image; adding a database entry to the database; and indexing the database entry by the determined arrangement of the symbols.

According to this method, information can be added to a database simply by scanning the puzzle cube to generate an index or label for the new database entry. The method may be applied to an array of dice or an array of symbols described above as well as to a puzzle cube.

Preferably, the database entries are website addresses. Alternatively, the database entries are user profiles.

Suitably, the database entries are lottery ticket numbers and the method further comprises: randomly selecting a winning one of the lottery ticket numbers in the database; and comparing the winning lottery ticket number with the lottery ticket number retrieved in the step of accessing the database to determine whether the arrangement of symbols is a winning arrangement.

Embodiments of the present invention will now be described by way of further example only and with reference to the accompanying drawings, in which:

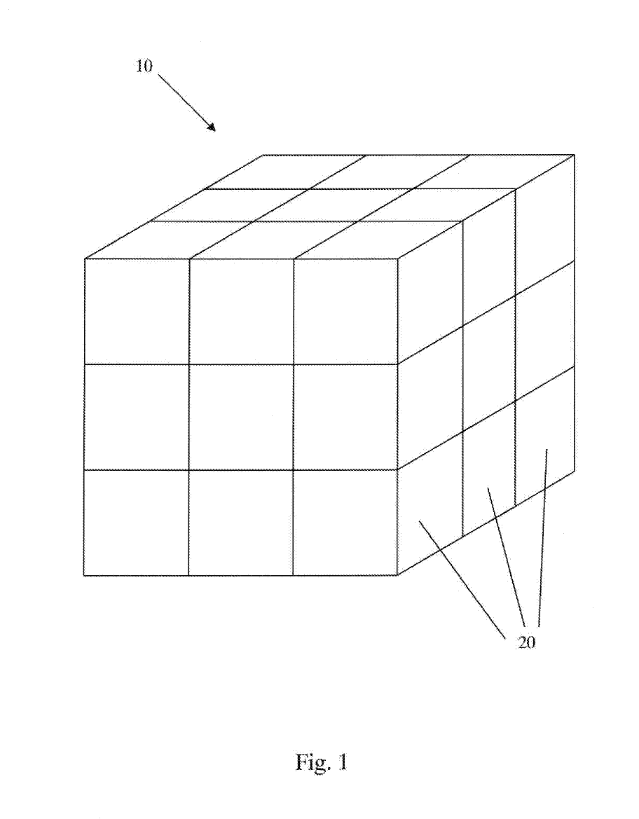

FIG. 1 is a perspective view of a puzzle cube according to an embodiment of the invention;

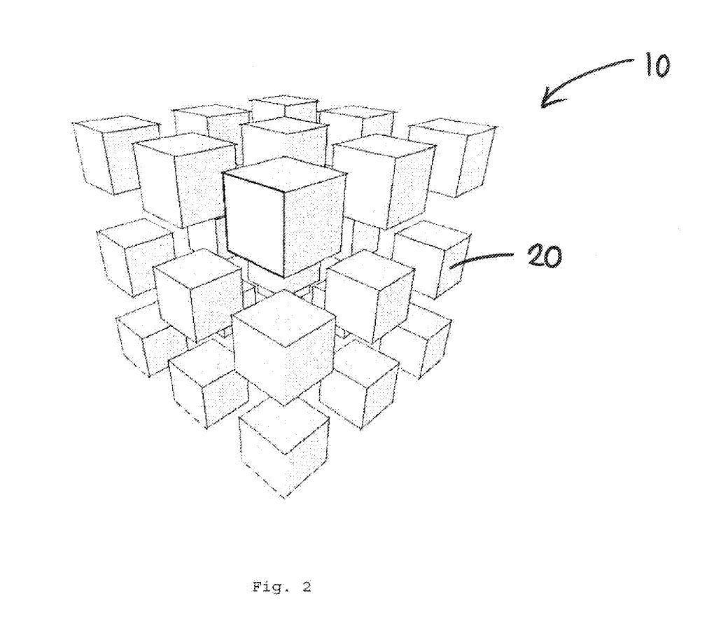

FIG. 2 shows the cubelets making up a puzzle cube according to an embodiment of the invention;

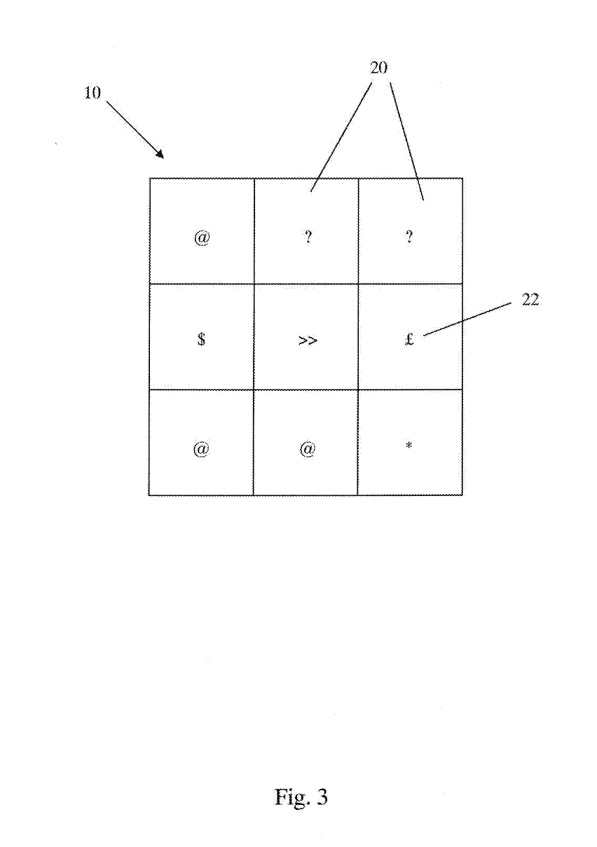

FIG. 3 shows an example of a face of a puzzle cube according to an embodiment of the invention in one configuration and also illustrates an array of symbols according to another embodiment of the invention;

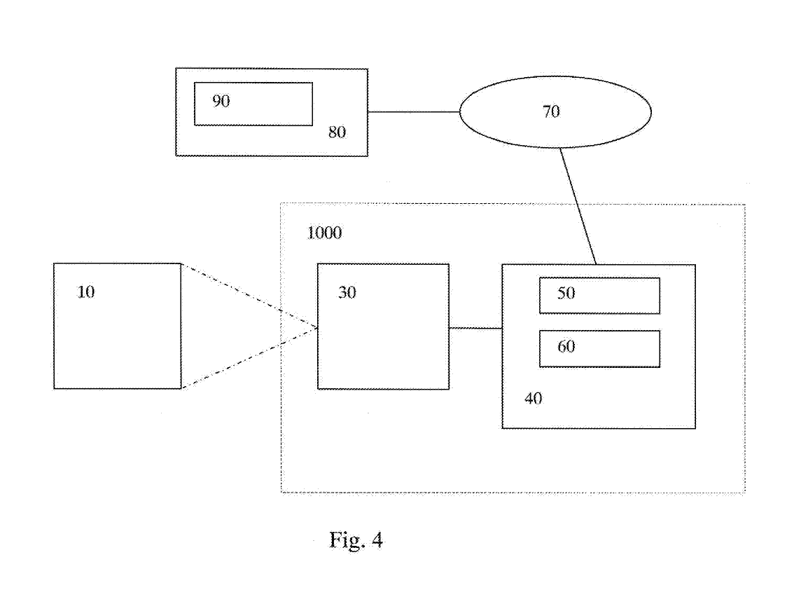

FIG. 4 is a block diagram of a communication system according to an embodiment of the invention;

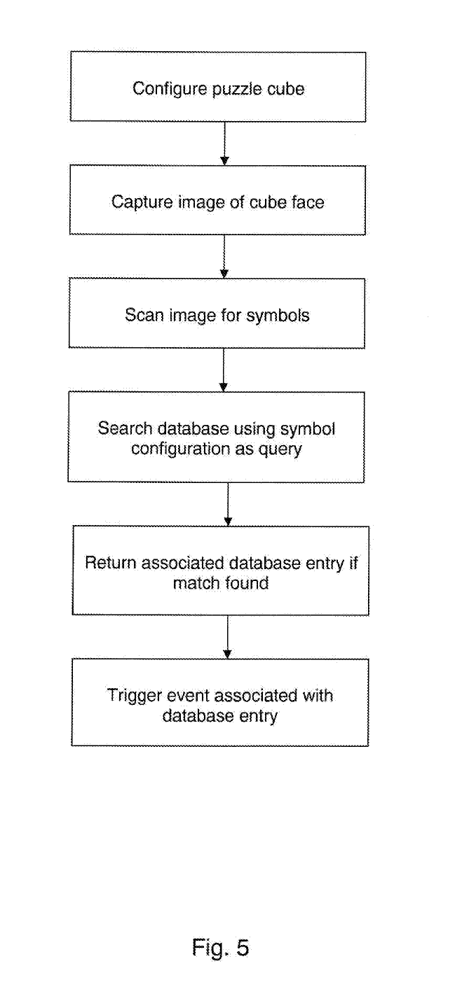

FIG. 5 is a flow diagram of a communication method according to an embodiment of the invention;

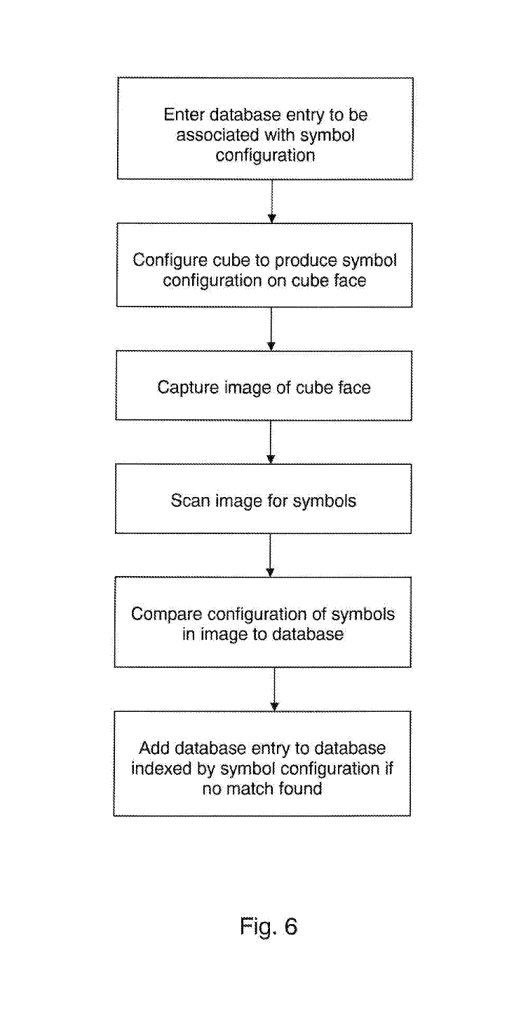

FIG. 6 is a flow diagram of another communication method according to an embodiment of the invention;

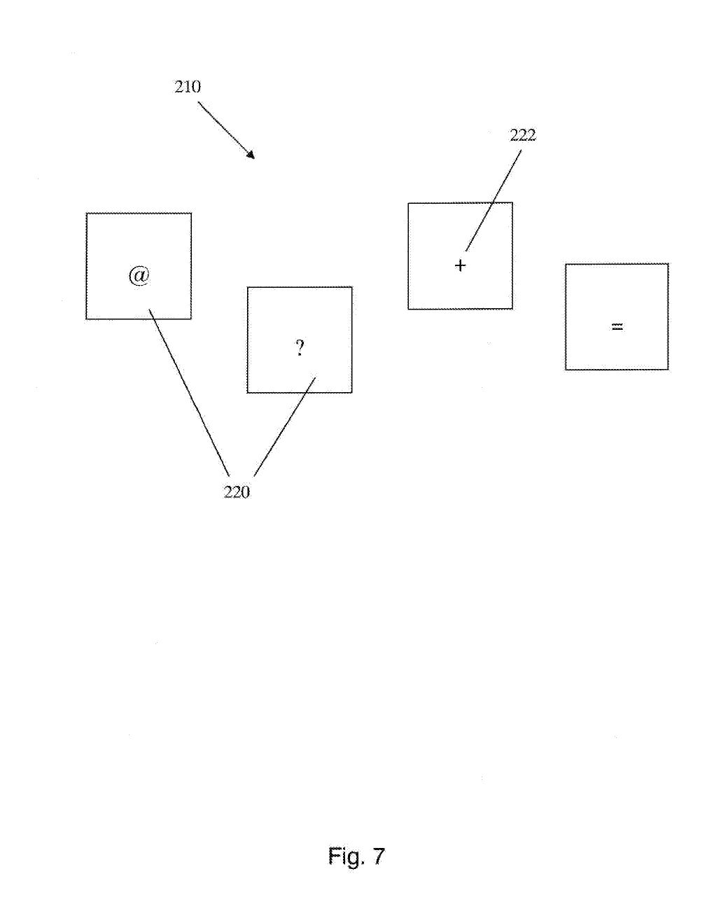

FIG. 7 shows a dice roll used in an alternative embodiment of the invention; and

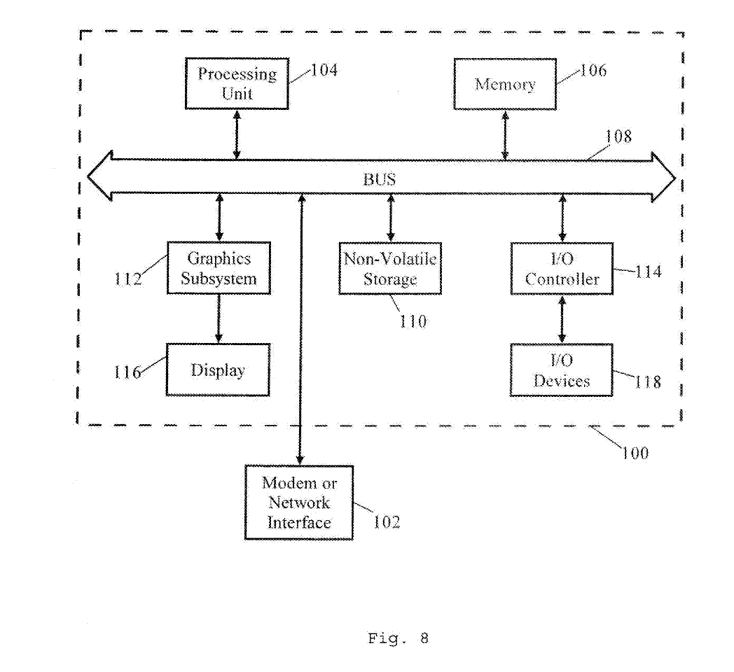

FIG. 8 shows an example of hardware in which an embodiment of the invention can be implemented.

As shown in FIGS. 1 and 2, the puzzle cube 10 according to an embodiment of the present invention consists of a plurality of cubelets 20. The puzzle cube 10 has a plurality of different symbols 22 displayed on different faces of the cubelets 20 respectively. In this embodiment the cube includes 26 cubelets forming a 3 by 3 array of 9 cubelet faces on each face of the puzzle cube 10. However, the invention can also be applied to puzzle cubes 10 consisting of any number of cubelets 20 per side, for example puzzle cubes 10 made up of 2 cubelets per side in a 2 by 2 by 2 arrangement. Similarly, the invention can be applied to puzzle cubes 10 having 4 or more cubelets per side.

The number of different symbols 22 attached to the cubelet faces of the cube is not limited, as long as there are at least two different symbols 22 so a variety of cube face configurations can be produced by rotating the cube faces. In one embodiment, six different symbols 22 are distributed across the cubelet faces in equal numbers so that rotating the cube faces can result in all of the cubelet faces making up each face of the cube displaying the same symbol.

In another preferred embodiment, seven different symbols 22 are used with the additional symbol being provided on six cubelet faces and the remaining cubelet faces being divided equally between the other six symbols 22. In this example, the cube can be rotated so that each face has one additional symbol and the remaining cubelet faces of the cube face all display the same one of the other six symbols 22. An example of a face of the cube in such an embodiment is shown in FIG. 3.

Alternatively, a different symbol may be provided on each cubelet face of the cube. This arrangement maximises the number of distinct cubelet configurations that the cube can be put into.

The type of symbols 22 shown on the cubelet faces is also not limited. For example, the symbols 22 may represent numbers, letters, well known signs such as “play”, “pause” or “rewind” symbols, cartoon characters, game characters and so on. The symbols 22 may have rotational symmetry, in which case they always appear correctly oriented no matter how the cube is configured. Alternatively, the symbols 22 may lack rotational symmetry, in which case more configurations are possible due to the different possible combinations of orientations of the symbols 22. In an alternative embodiment, blocks of different colours may be provided on the cubelet faces rather than symbols 22.

The system according to an embodiment of the invention is shown in FIG. 4. The system comprises the puzzle cube 10, a camera 30, a controller 40 including an image recognition component 50 and a database access component 60, and a storage device 80 storing a symbol configuration database 90. In a preferred embodiment, the camera 30 and the controller 40 form part of a mobile telephone 1000 and the image database is stored remotely and accessed via an Internet or other network connection 70, but the invention is not limited to this. The controller 40 may also be part of a laptop, tablet, head mounted display, other mobile computing device or desktop computer for example.

The camera 30 transmits image data captured by the camera 30 to the controller 40. The image recognition component 50 of the controller 40 is capable of recognising known features in the captured image, such as the cubelet symbols 22 or cubelet colours of the invention. The database access component 60 is capable of generating a search query for the database 90 based on the output of the image recognition component 50 and searching the database using the generated query. The controller 40 also has an internet connection 70, via which it can communicate with other devices such as the storage device 80.

The storage device 80 may be a server having a hard disk or other mass storage device, as is conventional. In an alternative embodiment, the symbol configuration database 90 may be contained in a storage device 80 local to the controller 40. For example, the symbol configuration database 90 could be stored in the flash memory of a mobile telephone 1000 having the controller 40. In this case, no internet connection is required to access the symbol configuration database 90.

In an alternative embodiment, the image recognition component 50 may be provided remotely from the camera 30 and the controller 40. In this case, the controller 40 passes image data captured by the camera 30 to the image recognition component 50 for processing.

The method according to an embodiment of the invention is shown in FIG. 5. The first step is for the user to configure the puzzle cube 10 by rotating its faces, so that a combination of symbols 22 or colours is displayed on each face. The image capture device such as a camera 30 is then used to capture an image of one of the faces of the configured cube. In the preferred embodiment, the system of the invention includes an app running on a mobile telephone 1000, i.e. a smartphone. The app allows the user to capture the image of the cube face using the camera 30 of the smartphone 1000 and the image is then stored by the app in the smartphone memory. The app contains an image recognition component 50, which is capable of recognising the combination of symbols 22 on the cube face captured in the image using known image recognition algorithms to perform the step of scanning the image for symbols 22. This can be implemented in a similar way to existing QR code scanner apps on mobile telephones.

Once the app has determined the combination of symbols 22 shown on the cube face from the captured image, the combination of symbols 22 is used as a query to search a stored database indexed by possible configurations of symbols 22 on a cube face. The database is stored in a storage device 80. In this embodiment, the storage device 80 is provided in a remote server which performs the database search using the query. The smartphone accesses the remote server via its Internet connection and sends the symbol configuration to the remote server for use as the query.

If a match for the symbol configuration is found in the database then the remote server returns the database entry stored in the database in association with the configuration of symbols 22 shown on the cube face. The smartphone 1000 can optionally then display the database entry to a user or perform another action based on the database entry returned from the database.

Various types of returned database entry and corresponding actions may be used in the invention. In a preferred embodiment, the database entry may be a link to content provided on a website or on a remote server accessed by the app via a network connection 70. When the link is returned by the remote server, the smartphone 1000 will display the content accessed via the link to the user. Since so many permutations of symbols 22 are possible on a face in a typical embodiment of the puzzle cube 10, e.g. a 3 by 3 by 3 cube having a different symbol on each cubelet face, it would theoretically be possible to link to every website in existence via unique configurations of the cube faces.

Alternatively, the database entry may link to a profile of a user either within the app or on a social network. Users may store their profile in the symbol configuration database 90 in association with a unique cube face symbol configuration using the app.

A method of storing a database entry in association with a captured cube face configuration is illustrated in FIG. 6. This method can be used to store a user profile as discussed above for example. The method is similar to that used when accessing a database entry using a captured cube face configuration, except that a new database entry is stored in association with the captured configuration rather than an existing entry being accessed.

First, the database entry to be added to the database is supplied. This can be any type of data but is information on a user profile in this embodiment. Next the cube is configured, an image of the face is captured and the image is scanned for symbols 22 as above. A check is then performed to determine whether the symbol configuration on the cube face is already present in the database. If so then an error message is returned and the user will have to reconfigure the cube. Otherwise, the new database entry, i.e. the user profile, is added to the database indexed by the symbol configuration corresponding to the puzzle cube face.

Subsequently, when the unique cube face symbol configuration is captured and compared to the database, the associated user profile is returned. In this way, a user can adopt a cube face configuration as a unique identifier that could be presented on a puzzle cube 10 or printed on a business card for example, allowing the user or others to access the user's profile automatically using the app.

Other types of database entry are possible. For example, the puzzle cube 10 could be used to play a lotto type game by allowing users to pick a cube face symbol configuration as an entry or “lottery ticket”. One or more winning cube face symbol configurations would then be chosen and the winning user could be notified.

Since the number of possible combinations of symbols 22 on one face of a 3 by 3 by 3 or larger puzzle cube 10 is vast, even if only six symbols 22 are used, there is no risk of the app running out of unique configurations to assign to users, content or game entries.

When a user first loads the app on the smartphone 1000 they will be invited to enter sufficient basic personal details to identify them as a user. These details are then used by the app to create a user profile, which is stored on a central server accessed by the app via the Internet. On subsequent uses of the app, the app can then identify the user who is capturing a particular cube face configuration or performing other actions within the app.

An optional feature of the puzzle cube 10 is a Near Field Communication (NFC) chip that can be embedded within the cube. The NFC chip may contain information uniquely identifying the particular cube it is attached to. With this feature, the app can communicate with the NFC chip using NFC communication hardware on the smartphone 1000 or other device on which it is run, and identify the cube being scanned. A cube's identifying information can be associated with a particular user profile in the app so that the user can be signed in to their profile automatically when the cube is scanned by the app.

In addition, the app may recognise movements of the cube as well as recognising the symbols 22 on a face of the cube. The camera 30 of the smartphone 1000 or other device captures the movement of the cube in this embodiment and a gesture recognition component is included in the app. The gesture recognition component interprets the movement captured by the camera 30 as one of a number of preset control gestures. Once the gesture made by the user with the cube has been interpreted, the app may respond in various ways. For example, the app could provide the user with extra content in response to the gesture or could activate or unlock a feature within the app.

In an alternative embodiment, the system of the invention uses a virtual cube in place of the physical puzzle cube 10. The virtual cube is a 3D simulation of the physical puzzle cube 10 running within the app. The user can manipulate the faces of the virtual cube in the same way as the faces of a physical cube by using the touchscreen of the smartphone 1000 or other input device.

In this embodiment, the same operations described above can be performed by rotating the faces of the virtual cube within the app to display a given combination of symbols 22. There is no need to capture an image in this embodiment, the combination of images on a selected face of the virtual cube is already known to the app and can be used to access the symbol configuration database 90 as described above.

The virtual cube embodiment has the advantage that a user can customise the symbols 22 attached to their virtual cube and the associated database entries in the symbol configuration database 90. The symbols 22 and database entries can be unique to the individual user and are stored by the app as part of the user profile.

An alternative to the puzzle cube 10 is using one or more individual symbol cubes or dice 210 to generate the combinations of symbols 22 used to access the database. Each die 220 is a cube or other polyhedron having a symbol 222 on each face. One or more of the dice 220 are rolled by the user and the upward facing faces of the dice 220 are captured by a camera 30 in the same way as described above for the puzzle cube face. An example of a symbol configuration resulting from such a dice roll is shown in FIG. 7. The combination of symbols 222 on the upward faces resulting from the dice roll can be used to access a symbol configuration database 90 and deliver content in all the same ways as described above for the puzzle cube 10.

Another alternative embodiment uses an array of symbols 22 or icons to access the database, without requiring a puzzle cube 10 or a set of dice. The array of symbols 22 may be one or two-dimensional and may consist of any number of individual symbols 22. For example, a 3 by 3 array of symbols 22 corresponding to a face of the puzzle cube 10 described above could be used, as shown in FIG. 3. The array of symbols 22 may be printed on a sheet of paper or other recording medium, or may be shown on an electronic display. The types of symbols 22 described above in relation to the puzzle cube 10 may also be used in this embodiment.

In this embodiment, the array of symbols 22 is scanned by an image capture device and the combination of symbols 22 in the array is detected by an image recognition component 50 as described above. The combination of symbols 22 is then compared to the database and can be used to retrieve a particular entry from the database or to store a new entry indexed by the combination of symbols 22, as also described above in relation to the puzzle cube 10 embodiment.

FIG. 8 illustrates an exemplary embodiment of a computer system 100 in which the system and method of the present invention may be realised. Both the controller 40 and the storage device 80 may be implemented in such hardware.

The computer system 100 may interface to external systems through a fixed wire or wireless connection or any other network interface 102 such as analog or ISDN modems, cable modems (ADSL/DSL), Ethernet or fibre optic interfaces, cellular or HSDS services and satellite transmission interfaces. As shown in FIG. 8, the computer system 100 includes a processing unit 104, which may be a conventional microprocessor, such as an Intel Core microprocessor or an ARM Cortex microprocessor, which are known to one of ordinary skill in the computer art.

System memory 106 is coupled to the processing unit 104 by a system bus 108. System memory 106 may be a DRAM, RAM, static RAM (SRAM) or any combination thereof. Bus 108 couples processing unit 104 to system memory 106, to non-volatile storage 110, to graphics subsystem 112 and to input/output (I/O) controller 114. Graphics subsystem 112 controls a display device 116, for example a liquid crystal display, which may be part of the graphics subsystem 112. The I/O devices may include one or more of a keyboard, tablet, stylus, disk drives, printers, a mouse, a touch screen or gesture driven interface and the like as known to one of ordinary skill in the computer art. The I/O devices may also include the camera 30.

The non-volatile storage 110 may be a magnetic hard disk, a flash memory or another form of storage for large amounts of data. Some of this data is often written by a direct memory access process into the system memory 106 during execution of the software in the computer system 100. The non-volatile storage 110 may contain the database 90.

The foregoing description has been given by way of example only and it will be appreciated by a person skilled in the art that modifications can be made without departing from the scope of the present invention.

1-16. (canceled)

17. A system for accessing a database comprising:
a puzzle cube including a plurality of cubelets forming rotatable faces of the puzzle cube, wherein a plurality of different symbols are respectively provided on a plurality of faces of the cubelets;
an image capturing device for capturing an image of a face of the puzzle cube;
an image recognition component communicably connected to the image capturing device and adapted to determine an arrangement of the symbols contained in the captured image;
a database containing a plurality of database entries, each database entry being indexed by an arrangement of the symbols; and
a database access component communicably connected to the image recognition component and to the database, the database access component being adapted to access the database and retrieve the database entry indexed by the arrangement of symbols determined by the image recognition component.

18. A system according to claim 17, further comprising a near field communication chip.

19. A system according to claim 17, wherein each face of the cube comprises a 3 by 3 array of cubelets.

20. A system according to claim 17, wherein each face of the cube comprises a 2 by 2 array of cubelets.

21. A system for accessing a database comprising:
a recording medium or electronic display having an array of symbols displayed thereon;
an image capturing device for capturing an image of the array of symbols;
an image recognition component communicably connected to the image capturing device and adapted to determine an arrangement of the symbols contained in the captured image;
a database containing a plurality of database entries, each database entry being indexed by an arrangement of the symbols; and
a database access component communicably connected to the image recognition component and to the database, the database access component being adapted to access the database and retrieve the database entry indexed by the arrangement of symbols determined by the image recognition component.

22. A system according to claim 21, wherein the array of symbols is a two-dimensional array.

23. A system according to claim 21, wherein the array of symbols includes at least two different symbols.

24. A system according to claim 17, wherein:
the database entries are user profiles;
the system further comprises a login component communicably connected to the database access component; and
the login component is adapted to allow a user of the system to access the user profile indexed by the arrangement of symbols determined by the image recognition component.

25. A method for retrieving information from a database comprising:
manipulating a puzzle cube to produce an arrangement of symbols on a face of the puzzle cube, wherein the puzzle cube includes a plurality of cubelets forming rotatable faces of the puzzle cube, and wherein a plurality of different symbols are respectively provided on a plurality of faces of the cubelets;
capturing an image of a face of the puzzle cube;
automatically determining an arrangement of the symbols contained in the captured image; and
accessing a database containing a plurality of database entries, each database entry being indexed by an arrangement of the symbols, using the determined arrangement of the symbols so as to retrieve the database entry associated with the determined arrangement of symbols.

26. A method for adding information to a database comprising:
manipulating a puzzle cube to produce an arrangement of symbols on a face of the puzzle cube, wherein the puzzle cube includes a plurality of cubelets forming rotatable faces of the puzzle cube, and wherein a plurality of different symbols are respectively provided on a plurality of faces of the cubelets;
capturing an image of a face of the puzzle cube;
automatically determining an arrangement of the symbols contained in the captured image;
adding a database entry to the database; and
indexing the database entry by the determined arrangement of the symbols.

27. A method according to claim 25, wherein the database entries are website addresses.

28. A method according to claim 25, wherein the database entries are user profiles.

29. A method according to claim 25, wherein the database entries are lottery ticket numbers and the method further comprises:
randomly selecting a winning one of the lottery ticket numbers in the database; and
comparing the winning lottery ticket number with the lottery ticket number retrieved in the step of accessing the database to determine whether the arrangement of symbols is a winning arrangement.
